(19) United States
(12) Patent Application Publication
(10) Pub. No.: US 2023/0098537 A1
(43) Pub. Date: Mar. 30, 2023

(54) INCREMENTAL LEARNING FOR MODELS WITH NEW FEATURES

(71) Applicant: International Business Machines Corporation, Armonk, NY (US)

(72) Inventors: Xiao Ming Ma, Xi'an (CN); Si Er Han, Xi'an (CN); Jing Xu, Xi'an (CN); Xue Ying Zhang, Xi'an (CN); Ji Hui Yang, Beijing (CN)

(21) Appl. No.: 17/484,236

(22) Filed: Sep. 24, 2021

(51) Int. Cl. G06N 20/00

(52) U.S. Cl. CPC G06N 20/00

(57) ABSTRACT

Using incremental learning techniques and statistic-based approaches to update models. In some instances, a set of residual values are calculated by extracting features by determining the difference between an original data model and a new data model. The calculated set of residual values are ultimately used to update the original model to produce a final data model that is structured and configured to seamlessly process data from both the original data model and the new data model.

### BACKGROUND

The present invention relates generally to the field of data modeling, and more particularly to the use of incremental learning methods to dynamically configure models to store and process data that contains features that were not necessarily present in the original model.

The Wikipedia entry for “Incremental Learning” (as of Aug. 30, 2021) states as follows: “In computer science, incremental learning is a method of machine learning in which input data is continuously used to extend the existing model's knowledge i.e. to further train the model. It represents a dynamic technique of supervised learning and unsupervised learning that can be applied when training data becomes available gradually over time or its size is out of system memory limits. Algorithms that can facilitate incremental learning are known as incremental machine learning algorithms. Many traditional machine learning algorithms inherently support incremental learning. Other algorithms can be adapted to facilitate incremental learning . . . The aim of incremental learning is for the learning model to adapt to new data without forgetting its existing knowledge. Some incremental learners have built-in some parameter or assumption that controls the relevancy of old data, while others, called stable incremental machine learning algorithms, learn representations of the training data that are not even partially forgotten over time . . . Incremental algorithms are frequently applied to data streams or big data, addressing issues in data availability and resource scarcity respectively. Stock trend prediction and user profiling are some examples of data streams where new data becomes continuously available. Applying incremental learning to big data aims to produce faster classification or forecasting times.”

### SUMMARY

According to an aspect of the present invention, there is a method, computer program product and/or system that performs the following operations (not necessarily in the following order): (i) receiving a first model, with the first model including an original data set, with the original data set including a plurality of original data values; (ii) receiving a new data set, with the new data set including a plurality of new data values; (iii) computing a set of residual data values based, at least in part, upon the plurality of original data values and the plurality of new data values; (iv) building a second model, with the second model being capable of having features and parameters that can accommodate the set of residual data values; (v) updating the first model to have the features and parameters that can accommodate the set of residual values; and (vi) combining the first model and the second model to obtain a final model, with the final model being structured and configured to process data contained in the original data set and the new data set.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system; and

FIG. 3 is a block diagram showing a machine logic (for example, software) portion of the first embodiment system.

### DETAILED DESCRIPTION

Some embodiments of the present invention are directed towards using incremental learning techniques and statistic-based approaches to update models. In some instances, a set of residual values are calculated by extracting features by determining the difference between an original data model and a new data model. The calculated set of residual values are ultimately used to update the original model to produce a final data model that is structured and configured to seamlessly process data from both the original data model and the new data model.

Additionally, some embodiments of the present invention are directed towards analyzing a new features effect for residual value(s) that are calculated by extracting original features effect from new target values and applying machine learning and statistics-based approaches in order to solve the problem of incremental learning for models with new features.

This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

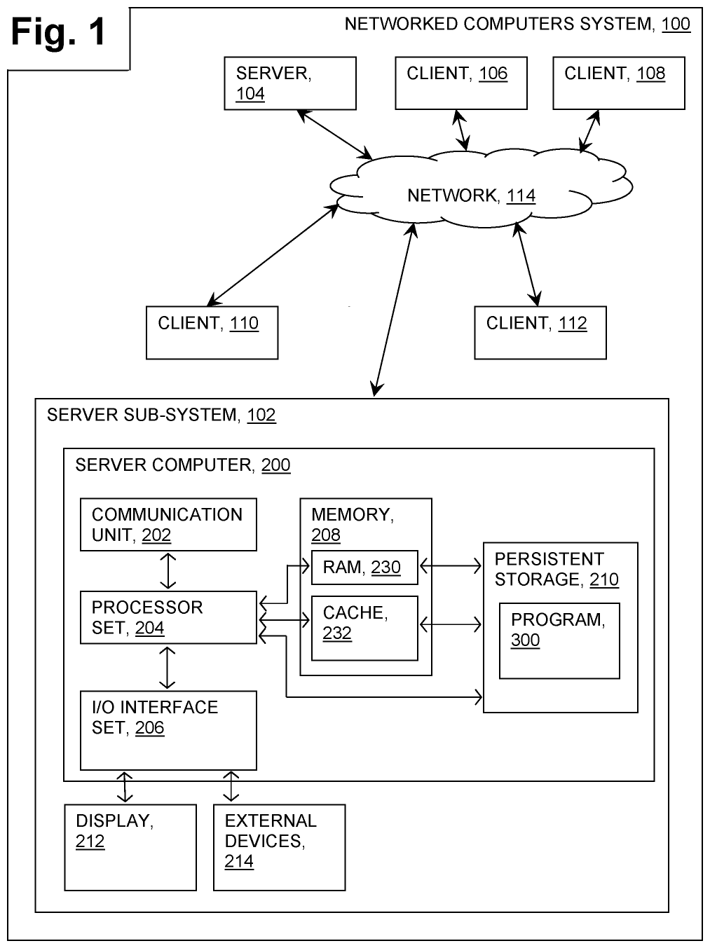

An embodiment of a possible hardware and software environment for software and/or methods according to the present invention will now be described in detail with reference to the Figures. FIG. 1 is a functional block diagram illustrating various portions of networked computers system 100, including: server sub-system 102; client sub-systems 104, 106, 108, 110, 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

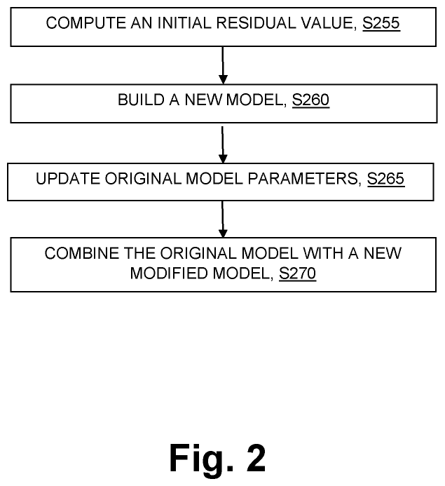

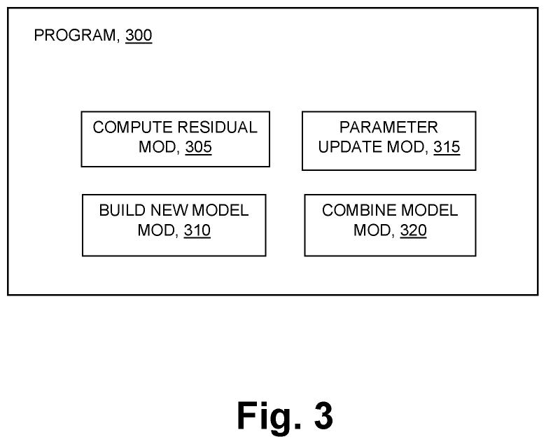

FIG. 2 shows flowchart 250 depicting a method according to the present invention. FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks).

Processing begins at operation 5255, where compute residual module (“mod”) 305 computes an initial residual value to ultimately create a model that is structured and configured to process new data that is of the type that is initially incompatible with the original model.

In some embodiments of the present invention, compute residual mod 305 divides the new data into three parts: (1) new feature part (referred to as XNEw); (2) original feature part (referred to as X); and (3) target part (referred to as Y). After dividing the data into these three aforementioned parts, compute residual mod 305 scores the first part (XNEw) with the original model to get a predicted value. After this, compute residual mod 305 gets the residual values by subtracting the predicted value from the target values.

Processing proceeds to operation S260, where build new model mod 310 begins to build a new model between the new features and the residual features. In some embodiments of the present invention, build new model mod 310 first checks to see whether there is a significant correlation between the new features and the residual values. In some embodiments, mod 310 computes a Pearson Correlation for each new feature and selects the features with the strongest (significant) correlation. Based upon this selection, build new model mod 310 creates a new model from the residual values and the selected new features.

Processing proceeds to operation S265, where parameter update mod 315 updates the original model parameters. In some embodiments of the present invention, certain data needs to be initially selected in order to update the original model. The process of selecting this original data involves at least the following operations:

(i) Subtract the new features effects for the target (R_{PREDICTED}) from the new data target (referred to as Y, and initially introduced in connection with operation S255, above) values. This will create a new data target (Y_{NEW}), which can be represented by the following equation:

Y_{NEW}=Y−R_{PREDICTED}

Combining Y_{NEW} with the new data (containing only the original features) creates a first dataset (Dataset_1); and

(ii) Use a random sampling methodology to select parts of records that are contained in the original data. This will create a second dataset (Dataset_2). In some embodiments of the present invention, the random sampling methodology includes the following operations (not necessarily in the following order): (i) obtain a large random number using a random number generator; (ii) the remainder of the large random number divided by the original data size is used as a “first selected element index”; (iii) select the next element with a fixed interval from the first selected element; (iv) select additional elements with the fixed interval from the original list circularly until a specified percentage value is obtained. In some embodiments of the present invention, the fixed interval can be calculated by dividing one (1) by the random selection rate.

In some embodiments of the present invention, parameter update mod 315 combines Dataset_1 and Dataset_2 to obtain a combined dataset (referred to as Dataset). Additionally, parameter update mod 315 creates and updated model by using Dataset to update the original model parameters.

In some embodiments of the present invention, the updated model must reach a specified accuracy. In the event that the updated model does not reach this specified accuracy, Dataset_2 will have to be updated by randomly sampling parts of the records that are contained in the original data. Dataset_2 will continually be updated until this specified accuracy is achieved.

Processing finally proceeds to operation S270, where combine model mod 320 combines the original model with the modified new model (X_{NEW}+X) (as discussed in connection with operation S260, above) to obtain a final model. This final model can be represented by the following equation:

Y=f_{final}(X_{new}+X)=g(X_{new})+f′(X)

### III. Further Comments and/or Embodiments

In some instances, after a model is built the new data that is used in this model increases the new features that are not originally included in the model. Typically, the model needs to be rebuilt with all the features included. However, in some instances, the new data that is used is not typically sufficient to build a good working model in order to keep the model stable for original data. In some instances, new features effects for certain targets need to be considered for new data that is used. Here, it is clear that an incremental learning methodology for models with new features is needed.

Some embodiments of the present invention provide a method for an incremental learning approach for models with new features that effect a given target. This method includes at least the following operations (not necessarily in the following order):

(i) Score new data with the original model to get a predicted value. Then, determine residual values by subtracting the predicted values from the target values;

(ii) Check whether the new features affect the residual value from operation (i) and select the features that have significant effects and build an additional (smaller) model between the residual features and the selected new features;

(iii) Subtract the new features effects for targets from target values as new targets and original features as predictors for new data. Then, add records that are randomly selected from the original data. Finally, use these two parts as a whole to update the original model parameters; and

(iv) Combine the original model and the new model to create a finalized model to use with the new data.

This method is discussed in greater detail with respect to flowchart 250 and program module 300, above.

As used throughout this document, the term “incremental learning” refers to embodiments of the present invention that provide a model learning method when new features are included (or are to be incorporated) and when records on an original model are not sufficient to rebuild the whole model. Additionally, some embodiments provide for a method that can make the final model stable for both original and new data.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above — similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

User/subscriber: includes, but is not necessarily limited to, the following: (i) a single individual human; (ii) an artificial intelligence entity with sufficient intelligence to act as a user or subscriber; and/or (iii) a group of related users or subscribers.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output/report: unless otherwise explicitly specified, these words should not be taken to imply: (i) any particular degree of directness with respect to the relationship between their objects and subjects; and/or (ii) absence of intermediate components, actions and/or things interposed between their objects and subjects.

Without substantial human intervention: a process that occurs automatically (often by operation of machine logic, such as software) with little or no human input; some examples that involve “no substantial human intervention” include: (i) computer is performing complex processing and a human switches the computer to an alternative power supply due to an outage of grid power so that processing continues uninterrupted; (ii) computer is about to perform resource intensive processing, and human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

Automatically: without any human intervention.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) comprising:
receiving a first model, with the first model including an original data set, with the original data set including a plurality of original data values;
receiving a new data set, with the new data set including a plurality of new data values;
computing a set of residual data values based, at least in part, upon the plurality of original data values and the plurality of new data values;
building a second model, with the second model being capable of having features and parameters that can accommodate the set of residual data values;
updating the first model to have the features and parameters that can accommodate the set of residual values; and
combining the first model and the second model to obtain a final model, with the final model being structured and configured to process data contained in the original data set and the new data set.

2. The CIM of claim 1 wherein the features and parameters that can accommodate the set of residual values include a set of values that are computed by extracting a predicted value from the second model.

3. The CIM of claim 2 wherein the predicted value from the second model is included in the target value of the plurality of new data values.

4. The CIM of claim 1 wherein the updated first model has a specified accuracy, with the specified accuracy being a value that is at or above a specified threshold value.

5. The CIM of claim 4 wherein the specified accuracy being below the specified threshold value triggers a random sampling of the new data set.

6. The CIM of claim 1 wherein the specified accuracy can be a user defined ratio, with the user defined ratio indicating a comparison between the accuracy of the plurality of new data values to the set of residual data values.

7. A computer program product (CPP) comprising:
a machine readable storage device; and
computer code stored on the machine readable storage device, with the computer code including instructions and data for causing a processor(s) set to perform operations including the following:
receiving a first model, with the first model including an original data set, with the original data set including a plurality of original data values,
receiving a new data set, with the new data set including a plurality of new data values,
computing a set of residual data values based, at least in part, upon the plurality of original data values and the plurality of new data values,
building a second model, with the second model being capable of having features and parameters that can accommodate the set of residual data values,
updating the first model to have the features and parameters that can accommodate the set of residual values, and
combining the first model and the second model to obtain a final model, with the final model being structured and configured to process data contained in the original data set and the new data set.

8. The CPP of claim 7 wherein the features and parameters that can accommodate the set of residual values include a set of values that are computed by extracting a predicted value from the second model.

9. The CPP of claim 8 wherein the predicted value from the second model is included in the target value of the plurality of new data values.

10. The CPP of claim 7 wherein the updated first model has a specified accuracy, with the specified accuracy being a value that is at or above a specified threshold value.

11. The CPP of claim 10 wherein the specified accuracy being below the specified threshold value triggers a random sampling of the new data set.

12. The CPP of claim 7 wherein the specified accuracy can be a user defined ratio, with the user defined ratio indicating a comparison between the accuracy of the plurality of new data values to the set of residual data values.

13. A computer system (CS) comprising:
a processor(s) set;
a machine readable storage device; and
computer code stored on the machine readable storage device, with the computer code including instructions and data for causing the processor(s) set to perform operations including the following:
receiving a first model, with the first model including an original data set, with the original data set including a plurality of original data values,
receiving a new data set, with the new data set including a plurality of new data values,
computing a set of residual data values based, at least in part, upon the plurality of original data values and the plurality of new data values,
building a second model, with the second model being capable of having features and parameters that can accommodate the set of residual data values,
updating the first model to have the features and parameters that can accommodate the set of residual values, and
combining the first model and the second model to obtain a final model, with the final model being structured and configured to process data contained in the original data set and the new data set.

14. The CS of claim 13 wherein the features and parameters that can accommodate the set of residual values include a set of values that are computed by extracting a predicted value from the second model.

15. The CS of claim 14 wherein the predicted value from the second model is included in the target value of the plurality of new data values.

16. The CS of claim 13 wherein the updated first model has a specified accuracy, with the specified accuracy being a value that is at or above a specified threshold value.

17. The CS of claim 16 wherein the specified accuracy being below the specified threshold value triggers a random sampling of the new data set.

18. The CS of claim 13 wherein the specified accuracy can be a user defined ratio, with the user defined ratio indicating a comparison between the accuracy of the plurality of new data values to the set of residual data values.
